(19) United States
(12) Patent Application Publication
(10) Pub. No.: US 2012/0254797 A1
(43) Pub. Date: Oct. 4, 2012

(54) INFORMATION PROCESSOR AND COMPUTER PROGRAM PRODUCT

(75) Inventors: Kentaro Nagahama, Tachikawa-shi (JP); Sumi Omura, Mitaka-shi (JP); Kensuke Horiuchi, Kunitachi-shi (JP); Takayuki Iida, Tachikawa-shi (JP)

(73) Assignee: KABUSHIKI KAISHA TOSHIBA, Tokyo (JP)

(21) Appl. No.: 13/305,598

(22) Filed: Nov. 28, 2011

(30) Foreign Application Priority Data
Mar. 31, 2011 (JP) 2011-078441

(51) Int. Cl. G06F 3/048

(52) U.S. Cl. 715/816

(57) ABSTRACT

According to one embodiment, an information processor includes a text selection module, a text analysis module, a keyword display module, and an action selection module. The text selection module receives an input of a portion selected from text being displayed. The text analysis module analyzes text information in the portion to extract a word or a word group as a keyword contained in the text information. The keyword display module displays a list of keywords extracted by the text analysis module and, if a specific keyword is selected, displays a list of actions corresponding to the specific keyword. The action selection module performs, if a specific action is selected from the list of actions, processing related to the specific action.

### CROSS-REFERENCE TO RELATED APPLICATIONS

This application is based upon and claims the benefit of priority from Japanese Patent Application No. 2011-078441, filed Mar. 31, 2011, the entire contents of which are incorporated herein by reference.

### FIELD

Embodiments described herein relate generally to an information processor and a computer program product.

### BACKGROUND

In applications such as browsers, user interfaces (typically, referred to as contextual menus) have been known that enable a user to select a desired action. Specifically, the user selects a range of text information in a displayed Web page using a drag function of a mouse and clicks the right button of the mouse on a selected character string (keyword) to display a list of various actions corresponding to the character string to select a desired action.

In conventional technologies, when a user designates a specific keyword for, for example, Web search as the action, a character string as the keyword needs to be correctly selected. For example, equipment such as a touch panel for selecting a range of text information using a finger requires fine operation.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of the appearance of a slate personal computer (PC) according to an embodiment;

FIG. 2 is an exemplary block diagram of the hardware configuration of the slate personal computer in the embodiment;

FIG. 3 is an exemplary block diagram of a software configuration according to a first embodiment;

FIG. 4 is an exemplary diagram of a screen structure in the first embodiment;

FIG. 5 is an exemplary diagram of the screen structure in the first embodiment;

FIG. 6 is an exemplary diagram of the screen structure in the first embodiment;

FIG. 7 is an exemplary flowchart of the operation of the first embodiment;

FIG. 8 is an exemplary block diagram of a software configuration according to a second embodiment;

FIG. 9 is an exemplary diagram of a screen structure in the second embodiment;

FIG. 10 is an exemplary diagram of the screen structure in the second embodiment;

FIG. 11 is an exemplary diagram of the screen structure in the second embodiment; and

FIG. 12 is an exemplary flowchart of the operation of the second embodiment.

### DETAILED DESCRIPTION

In general, according to one embodiment, an information processor comprises a text selection module, a text analysis module, a keyword display module, and an action selection module. The text selection module is configured to receive an input of a portion selected from text being displayed. The text analysis module is configured to analyze text information in the portion to extract a word or a word group as a keyword contained in the text information. The keyword display module is configured to display a list of keywords extracted by the text analysis module and, if a specific keyword is selected, to display a list of actions corresponding to the specific keyword. The action selection module is configured to, if a specific action is selected from the list of actions, perform processing related to the specific action.

Exemplary embodiments will be described in detail below with reference to the accompanying drawings. In the following embodiments, a slate personal computer (PC) is taken as an example of an information processor, but the information processor is not limited to this. The information processor may be any electronic device capable of receiving information, processing the information, and outputting the information by displaying it and the like such as, for example, other types of computers, personal digital assistants (PDAs), cellular phones, and television receivers.

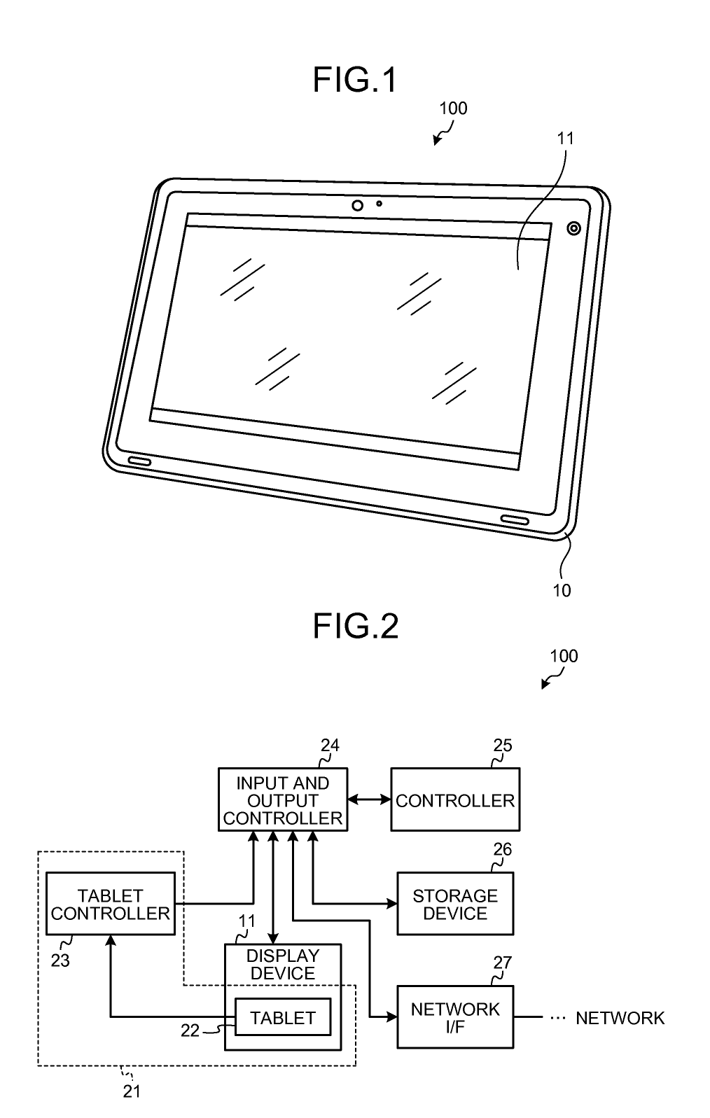

A slate PC 100 according to an embodiment will be described. FIG. 1 is a schematic diagram of the appearance of the slate PC 100 according to the embodiment.

The slate PC 100 is a computer system comprising a display device 11 that comprises, on its surface, a touch panel for detecting the coordinate position of a pen, a finger, or the like and the area of the contact surface with it.

As illustrated in FIG. 1, in the slate PC 100, a computer main body 10 comprises a display panel (display screen) of a liquid crystal display (LCD) and the display device 11 comprising a tablet (touch panel) integrally provided with the surface of the display panel. The computer main body 10 has various types of built-in hardware, which will be described later.

The hardware configuration of the slate PC 100 will be described with reference to FIG. 2. FIG. 2 is a block diagram of the hardware configuration of the slate PC 100.

As illustrated in FIG. 2, the slate PC 100 comprises a tablet input device 21 as a data input device. The tablet input device 21 comprises a tablet (touch panel) 22 and a tablet controller 23 that converts the coordinate position of a pen, a finger, or the like and the area of the contact surface with it that are detected by the tablet 22 into input data.

The computer main body 10 also comprises an input and output controller 24. The input and output controller 24 transfers data received from the tablet controller 23 to a microprocessor (central processing unit (CPU)) in a controller 25 and controls output operations of the display device 11 and input and output operations in or from a storage device 26 such as a hard disk drive (HDD) and a solid state drive (SSD) under the control of the CPU. The controller 25 comprises a system memory of a random-access memory (RAM) and the like into which an operating system (OS) and various applications are loaded and which is also used as a work area, and a memory device such as a basic input/output system read-only memory (BIOS ROM).

A network interface (I/F) 27 connected to the input and output controller 24 is an interface for connecting to an external server (not illustrated) or the like via a network such as the Internet and a local-area network (LAN). The slate PC 100 can download desired programs and content from the external server or the like via the network I/F 27. While the network is described herein byway of example as a wireless LAN, it may also be a wired LAN.

The hardware configuration described above is similarly applied to a first embodiment and a second embodiment described below.

According to the first embodiment, an application program in which a user selects a character string including keywords implements functions of extracting a keyword and displaying the extracted result, and the like.

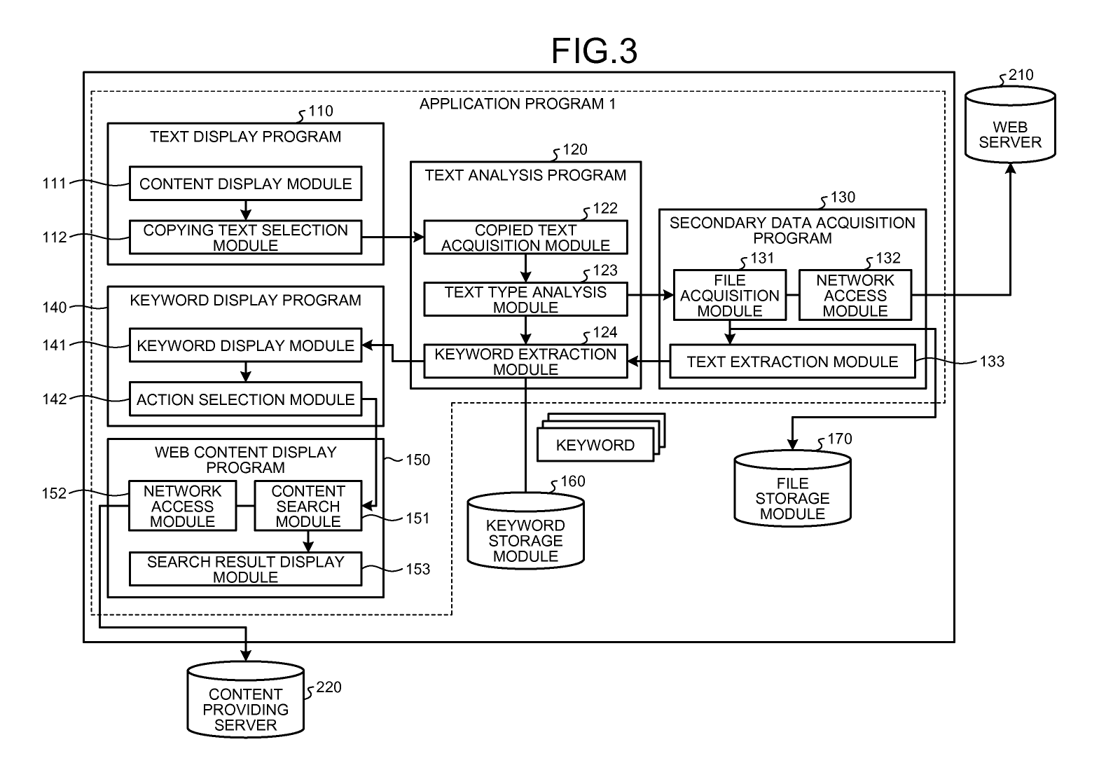

The software configuration in the first embodiment will be described with reference to FIG. 3. FIG. 3 is a block diagram of the software configuration of the first embodiment. The CPU in the slate PC 100 (information processor) cooperates with the OS as basic software and executes each program illustrated in FIG. 3 to implement the functions of an information processing program and each module thereof, which will be described below.

A text display program 110 illustrated in FIG. 3 is, for example, a Web browser capable of displaying text, a text viewer, and file editing software such as a word processor, spreadsheet software, and presentation software.

In the text display program 110, its content display module 111 causes the display device 11 to display content containing text. When a user selects the whole or part of text information displayed on the display screen, a copying text selection module 112 receives the selection as an input (copy) of the text information and outputs the selected data to a copied text acquisition module 122 described below. The copying text selection module 112 may feeds the text information to the copied text acquisition module 122 in several manners. For example, the copying text selection module 112 may directly output data to the copied text acquisition module 122. For another example, the copying text selection module 112 may once store the text information in a copied data storage module in the slate PC 100 (hereinafter, abbreviated as in the processor) or on a network, and output the positional information of the stored data to the copied text acquisition module 122 so that the copied text acquisition module 122 can acquire the data from the copied data storage module based on the positional information.

A text type analysis module 123 analyzes whether the copied data is text data. When the copied data is text data, the text type analysis module 123 further identifies whether the text data is address information (hereinafter, link information) indicating the storage position of the copied data on the network or in the processor or whether the text data is a character string except for the link information. The term “text data” as used herein refers to character string data having a given length specified as a character code (ASCII, Shift-JIS, and the like). When the copied data is link information, notification of the link information is provided to a file acquisition module 131 of a secondary data acquisition program 130.

The file acquisition module 131 identifies whether the address indicated by the link information is positional information (for example, C:¥xxx¥xxx¥aaa.txt) of a file storage module 170 in the processor or positional information (such as a uniform resource locator (URL)) on a network server. When the address is the positional information of the file storage module 170 in the processor, file data designated by the link information is acquired from the file storage module 170. When the address is the positional information on a network server, file data designated by the link information on the network server (for example, a Web server 210) is acquired via a network access module 132 through an Internet Protocol (IP).

A text extraction module 133 analyzes the file data acquired by the file acquisition module 131 and extracts text data in the file data. During the text data extraction, the text data is extracted so as to be associated with the attribute information of the text data. The attribute information of the text data indicates the display position of the text data in the file data, the size, colors, presence or absence of emphasis processing of characters, and the like. The extracted data is fed to a keyword extraction module 124 of a text analysis program 120.

The keyword extraction module 124 analyzes the acquired text data and attribute information and extracts characteristic keywords and related information of the keywords while referring to a keyword dictionary. The related information of the keywords herein includes word class of the keywords, noun category (for example, names of people, names of places, and general nouns) of the keywords, and criticality of the keywords but can be optionally defined. Such related information can be utilized, for example, when information is searched as an action corresponding to the keywords. After the keyword extraction processing is completed, the keyword extraction module 124 records the extracted keywords and their related information in a keyword storage module 160 regardless of the number of the extracted keywords. The keyword extraction module 124 may also record keywords and their related information that have been held in the keyword storage module 160 before the keyword extraction, that is, keywords and their related information that have been stored during last keyword extraction in a past keyword storage module (not illustrated) and record the keywords and their related information that are extracted at this time in the keyword storage module 160.

When a user or an application program 1 starts up a keyword display program 140, its keyword display module 141 acquires keywords most newly extracted from the keyword storage module 160 and displays the keywords on the display screen as a list. A keyword is selected from the list to together display a list of one or more executable actions using the keyword. A user selects one action from the displayed actions, and thus, an action selection module 142 performs processing related to the selected action. Examples of the actions include copy, Web search, moving image search, image search, and commercial products search.

When the processing performed by the action selection module 142 is the search of contents on a network server, a content search module 151 of a Web content display program 150 searches contents related to the keyword from one or more network servers (content server 220) via a network access module 152 through an IP. The content herein includes Web pages, static images, moving images, music, and commercial products information handled in Internet retailing.

A search result display module 153 of the Web content display program 150 displays a content search result searched by the content search module 151 on the display screen. When a user selects one content from the content search result, processing related to the content (such as display of detailed information, access to sales sites, and download of contents) is executed.

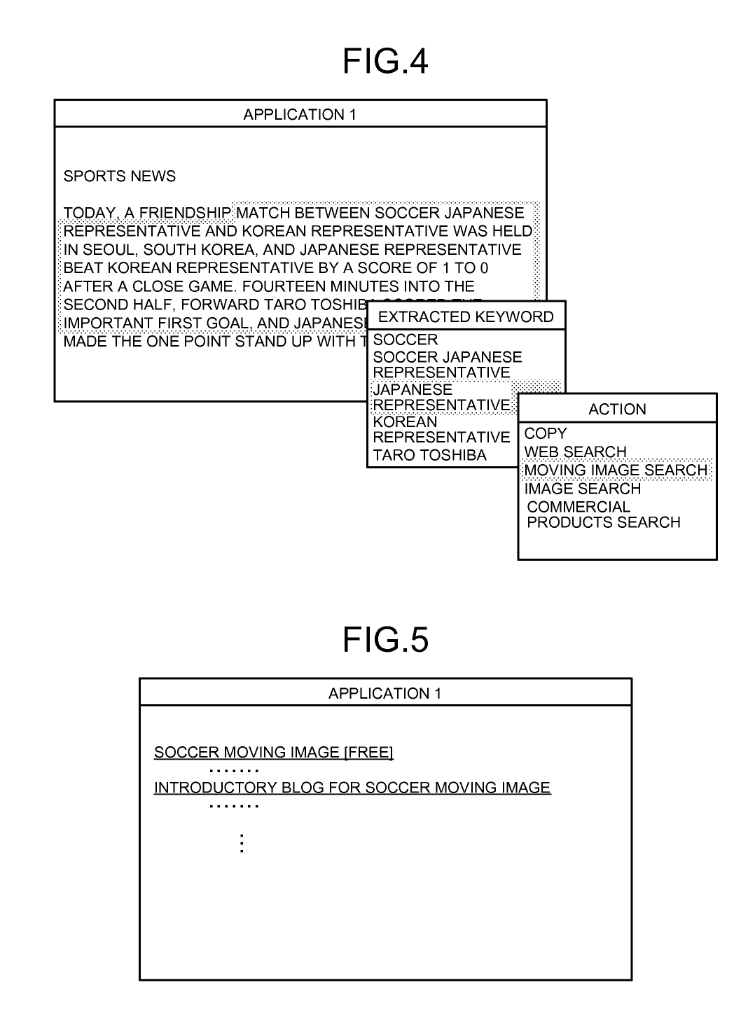

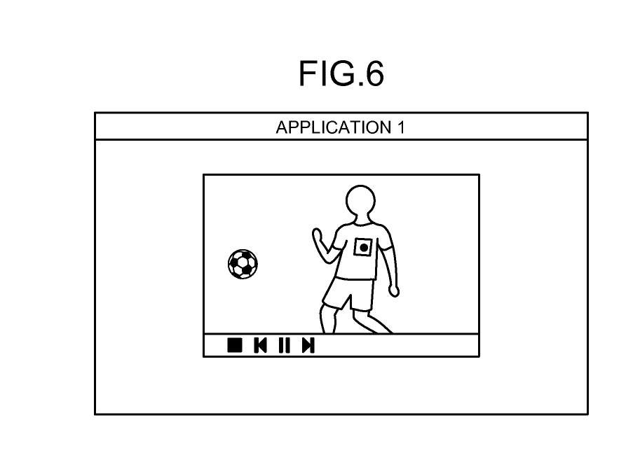

FIGS. 4 to 6 illustrate screen structure examples according to the first embodiment. When a user selects and copies a given portion of displayed text data on an application program, one or more keywords are extracted from the copied text information, and the extracted keywords are displayed as a list at an overlapping position of the selected text data or near the position. A keyword is selected from the list to display a list of one or more executable actions together using the keyword (FIG. 4). A user selects one action from the displayed actions, and thus, the action selection module 142 executes processing related to the selected action. In an example of FIG. 4, an action “moving image search” corresponding to a keyword “Japanese representative” is selected. In response to the selection, a Web search result is displayed on the application program (FIG. 5), and a user further selects a desired link from the search result to display the content (moving image) (FIG. 6).

Keywords are displayed automatically at timing when text is selected on a touch panel after the keyword extraction. In addition to this, it is considered to display the keywords, for example, when a user overlays a mouse cursor on the selected text, when a user performs operations such as click of a mouse on the selected text and touch of the selected text with the fingers, when a user selects the text to execute a copy command, and when a user selects the text to copy it and further clicks the text with a mouse, touches it with the fingers, or performs other operations.

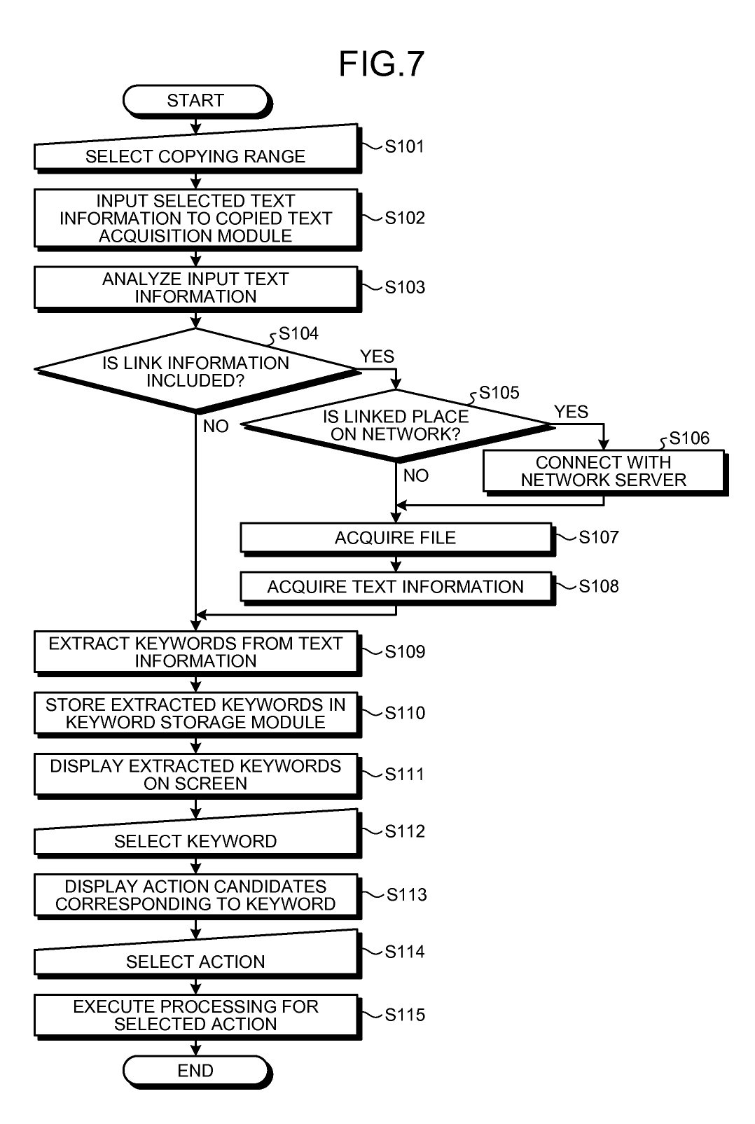

The processing example in the first embodiment will be described with reference to FIG. 7. FIG. 7 is a flowchart of an example of the operation of the first embodiment.

When a user selects a character string (copying range) with at least one character as text information on a specific application (S101), the application program outputs the selected text information to the copied text acquisition module 122 (S102). The text information may be fed to the copied text acquisition module 122 in several manners as described above. For example, the copying text selection module 112 may directly output data to the copied text acquisition module 122. For another example, the copying text selection module 112 may once store the text information in the copied data storage module in the processor or on a network, and output the positional information of the stored data to the copied text acquisition module 122.

The copied text acquisition module 122 outputs the input text information to the text type analysis module 123. The text type analysis module 123 analyzes whether the text information contains an address of a data storage place in the processor or a data storage place on a network server (S103).

As a result of the analysis performed by the text type analysis module 123, if the input text information includes link information (Yes at S104), the text type analysis module 123 further judges whether the linked place is a data storage place in the processor or a data storage place on a network (S105). On the other hand, if the input text information does not include link information (No at S104), the system control goes to S109.

If the linked place is the data storage place in the processor (that is, if the linked place is not on a network) (No at S105), the file acquisition module 131 acquires a file at the linked place from the data storage place in the processor (S107). On the other hand, if the linked place is on a network (Yes at S105), the file acquisition module 131 is connected with a corresponding network server through an IP network via the network access module 132 (S106) to acquire a file at the linked place (S107).

The text extraction module 133 extracts text information in the file acquired at S107 to acquire the text information (S108).

The keyword extraction module 124 analyzes the extracted text information using a predetermined rule to acquire keyword information and attribute information related to the keywords that are contained in the text information (S109). The keyword extraction herein is not limited to a specific method but can be simply performed by previously preparing candidates of keywords and extracting a character string in the text information as keyword information when the character string corresponds to one of the candidates. Examples of the attribute information related to the keywords herein include times when the keywords are extracted and a search utilization flag indicating whether the keywords are utilized for content search.

The extracted keyword information and attribute information thereof are stored in the keyword storage module 160 (S110). The keyword storage module 160 herein comprises a data table exemplified in Table 1 below and stores therein times when the keywords as their relating attribute information are extracted and the search utilization flag indicating whether the keywords are utilized for content search. The times when the keywords are extracted and the search utilization flag that are exemplified in Table 1 can be utilized in order to know utilization status by users and other information.

TABLE 1

| | | Search utilization |
|---|---|---|
| Keyword | Extraction time | flag |
| Swimming | 2010/11/20 15:30 | True |
| Competitive | 2010/11/20 15:30 | False |
| swimming | | |
| Butterfly | 2010/11/20 15:30 | False |
| Marathon | 2010/11/20 15:25 | False |
| Soccer | 2010/11/20 15:25 | True |
| . . . | . . . | . . . |

The keyword display module 141 displays keywords extracted by the text extraction module 133 near the selected text range as a keyword list on the application in which the text is selected at S101 (S111). Moreover, when a user selects one keyword from the displayed keyword list (S112), the keyword display module 141 displays executable action candidates near the keyword list or other places as a list using the keyword based on a data table exemplified in Table 2 below (S113). The action list is thus displayed herein, but a specific action may also be performed at the time when the keyword is selected. Information of executable actions corresponding to each keyword is previously prepared in the storage device 26 or in a storage place on a network in a form of a table exemplified in Table 2 or the like.

TABLE 2

| Keyword | Executable action |
|---|---|
| . . . | . . . |
| Soccer | Copying, web search, moving image |
| | search, image search, and commercial |
| | products search |
| Japanese | Copying, web search, moving image |
| representative | search, image search, and commercial |
| | products search |
| . . . | . . . |

A user selects a desired action from the displayed action list (S114), and then, the action selection module 142 executes processing related to the selected action (S115).

In the first embodiment, keywords related to user tastes can be extracted by simply roughly selecting the range that is of interest for users from contents, and actions related to the keywords can be performed.

According to the second embodiment, an application program different from the application program in which a user selects a character string including keywords implements functions of extracting a keyword and displaying the extracted result, and the like.

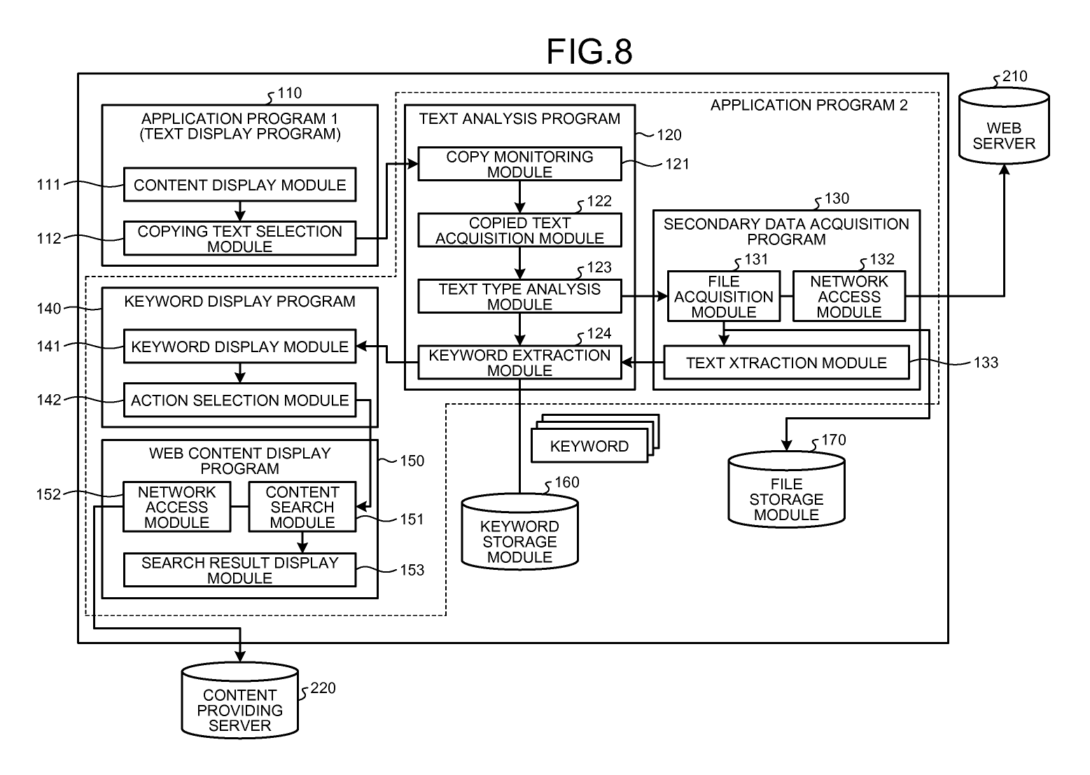

The software configuration in the second embodiment will be described with reference to FIG. 8. FIG. 8 is a block diagram of the software configuration of the second embodiment. The CPU in the slate PC 100 (information processor) cooperates with an OS as basic software and executes each program illustrated in FIG. 8 to implement the functions of an information processing program and each module thereof, which will be described below.

The software configuration of the second embodiment is different from that of the first embodiment in that the text analysis program 120, the secondary data acquisition program 130, the keyword display program 140, and the Web content display program 150 are configured to be a program different from the application program 1 in which a user selects text. Moreover, they are different in that the text analysis program 120 comprises a copy monitoring module 121 and in a method of receiving and outputting text information from the copying text selection module 112 to the copied text acquisition module 122. The other structure is common and different points are described below.

FIG. 8 illustrates an application program 2 comprising the text analysis program 120, the secondary data acquisition program 130, the keyword display program 140, and the Web content display program 150. Each of these programs may be implemented in the one application program 2 in such a manner, but these programs may also be implemented as individual programs.

When a user selects the whole or a part of text information displayed on the display screen, the copying text selection module 112 in the second embodiment receives the selection as an input of the text information and stores the selected data in a copied data storage module such as a clipboard. In the second embodiment, the copied data storage module is a device or a storage device (for example, a memory) in the processor but may be provided on a server through a network.

The copy monitoring module 121 of the text analysis program 120 provided in the second embodiment has a function of monitoring that some data is stored in the copied data storage module.

The copied text acquisition module 122 in the second embodiment acquires copied data from the copied data storage module when the copy monitoring module 121 detects that the copied data storage module stores the data.

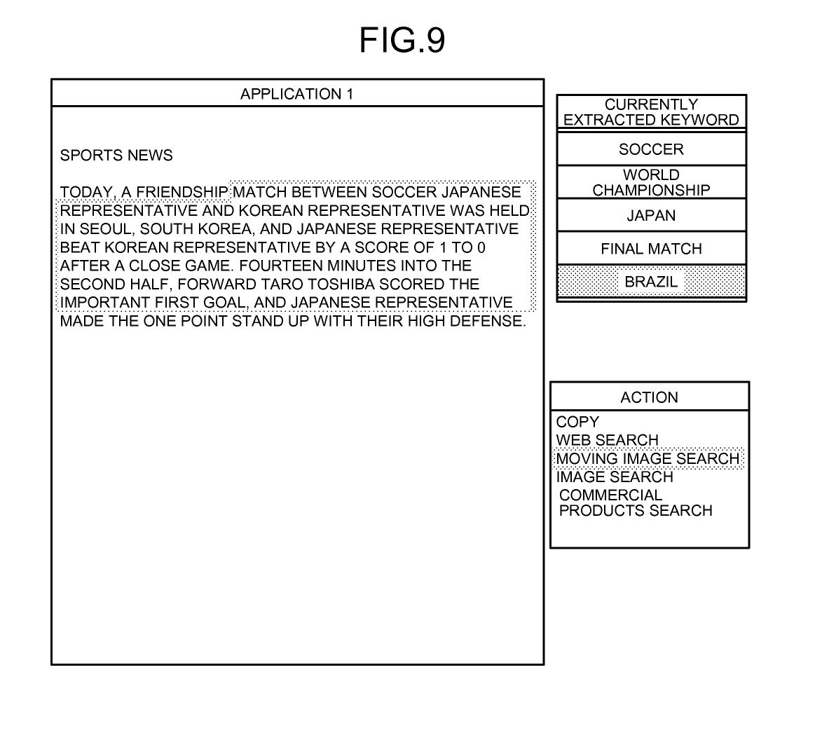

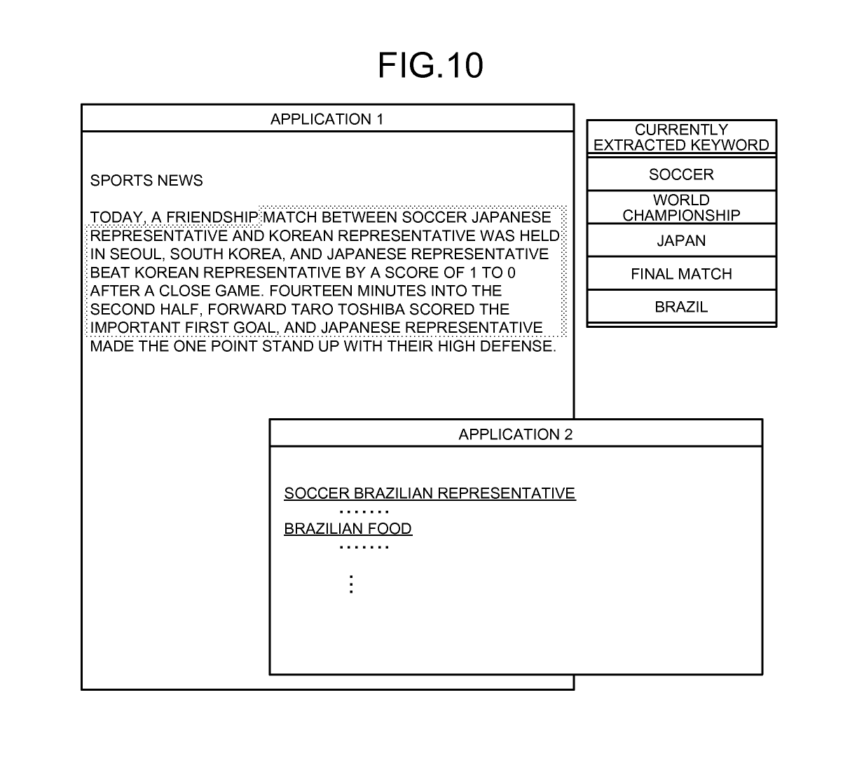

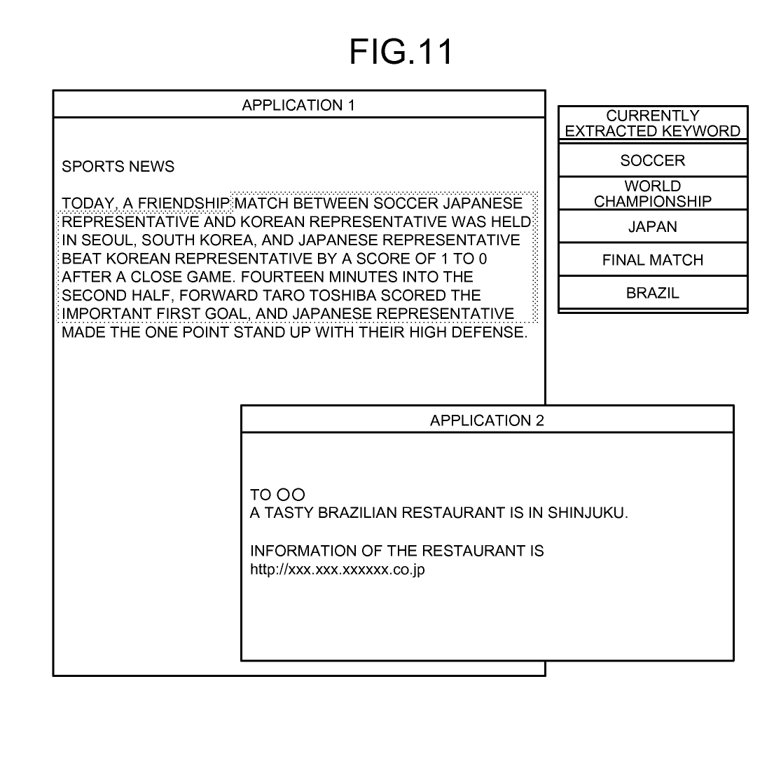

FIGS. 9 to 11 illustrate screen structure examples in the second embodiment. When a user selects and copies a given portion of displayed text data on the application program (1), one or more keywords are extracted from the copied text information, and the extracted keywords are displayed as a list on the display screen in a predetermined display area. When a keyword is selected from the list, a list of one or more executable actions is displayed together using the keyword (FIG. 9). A user selects one action from the displayed actions, and thus, the action selection module 142 executes processing related to the selected action. In the example of FIG. 9, an action “Web search” corresponding to a keyword “Brazil” is selected. In response to the selection, a Web search result is displayed on the application program 2 different from the application program 1 (FIG. 10), and a user further selects a desired link from the search result to display the content (FIG. 11). The timing of displaying keywords is the same as that of the first embodiment.

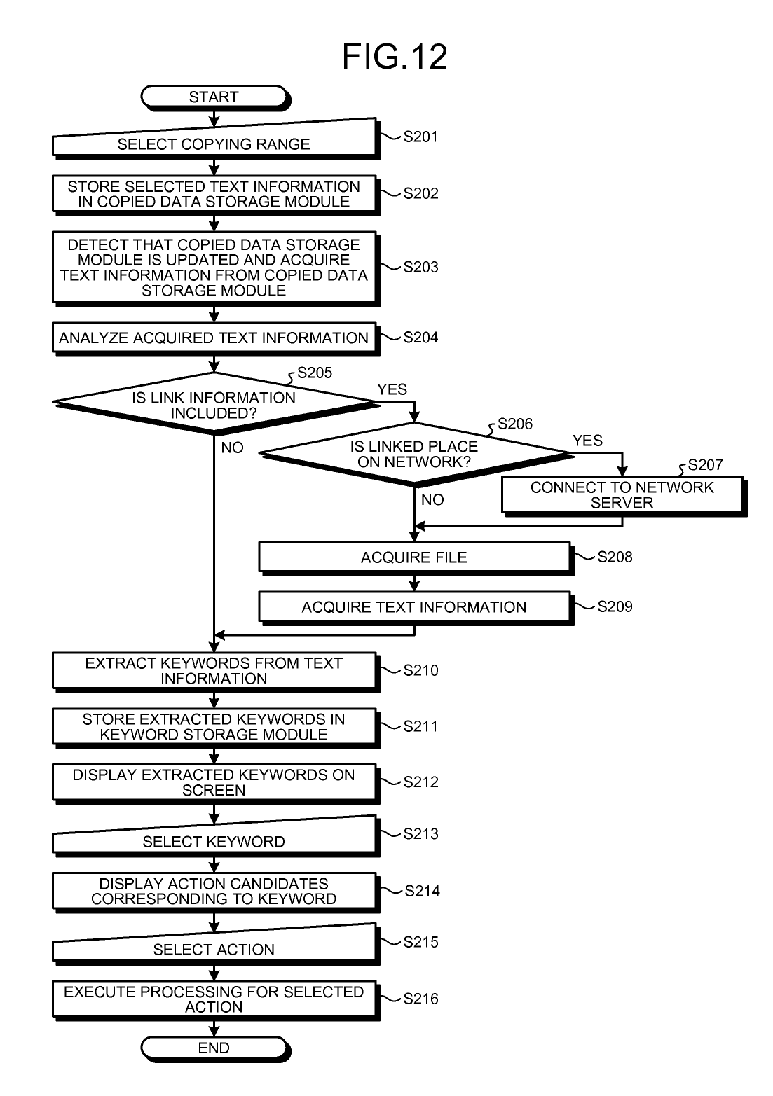

An example of the operation of the second embodiment will be described with reference to FIG. 12. FIG. 12 is a flowchart of an example of the operation of the second embodiment.

When a user selects a character string (text information) with at least one character on a specific application (the application program 1) (S201), the copying text selection module 112 in the application program stores the selected text information in the copied data storage module in the processor (or on a network) (S202).

When the copying text selection module 112 once stores the text information in the copied data storage module, the copy monitoring module 121 detects the data storage. In response to the detection, the copied text acquisition module 122 acquires the text information (S203).

The copied text acquisition module 122 outputs the acquired text information to the text type analysis module 123. The text type analysis module 123 analyzes whether the text information contains an address of a data storage place in the processor or a data storage place on a network server (S204).

As a result of the analysis performed by the text type analysis module 123, if the acquired text information includes link information (Yes at S205), the text type analysis module 123 further judges whether the linked place is a data storage place in the processor or a data storage place on a network (S206). On the other hand, if the input text information does not include link information (No at S205), the system control goes to S210.

If the linked place is the data storage place in the processor (that is, if the linked place is not on a network) (No at S206), the file acquisition module 131 acquires a file at the linked place from the data storage place in the processor (S208). On the other hand, if the linked place is on a network (Yes at S206), the file acquisition module 131 is connected with a corresponding network server through an IP network via the network access module 132 (S207) to acquire the file at the linked place (S208).

The text extraction module 133 extracts text information in the file acquired at S208 to acquire the text information (S209).

The keyword extraction module 124 analyzes the extracted text information using a predetermined rule to acquire keywords and attribute information related to the keywords that are contained in the text information (S210). The extracted keywords and attribute information thereof are stored in the keyword storage module 160 (S211). The keyword storage module 160 comprises the data table exemplified in Table 1 in the first embodiment.

The keyword display module 141 displays keyword information extracted by the text extraction module 133 as a keyword list on a display screen different from that of the application program 1 in which the text is selected at S201 at a predetermined position (S212). Moreover, when a user selects one keyword from the displayed keyword list (S213), the keyword display module 141 displays executable action candidates near the keyword list or other places as a list using the keyword based on the data table exemplified in Table 2 (S214). The action list is thus displayed herein, but a specific action may also be performed at the time when the keyword is selected. Information of executable actions corresponding to each keyword is previously stored in the storage device 26 or in a storage place on a network to be prepared, for example, as a data table exemplified in Table 2 as with the case of the first embodiment.

A user selects a desired action from the displayed action list (S215), and then, the action selection module 142 executes processing related to the selected action (S216).

The second embodiment can implement from keyword extraction from the selected text to actions corresponding to keywords even when text (character string) selection is performed on any application as compared with the first embodiment.

As described above, according to the embodiments described above, if a user only roughly selects a vague range including a character string containing desired keywords or keywords related to user tastes, for example, a range that is of interest for the user on content containing text, actions corresponding to the keywords can be performed.

The information processing program executed on the information processer such as the slate PC 100 of the embodiment or the like maybe provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The information processing program may also be stored in a computer connected via a network such as the Internet so that it can be downloaded therefrom via the network. Further, the computer program may be provided or distributed via a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
a text selection module configured to receive an input comprising a portion of text being displayed;
a text analysis module configured to analyze text information in the portion and to extract a word or a word group as a keyword contained in the text information;
a keyword display module configured to display a list of keywords extracted by the text analysis module and, when a keyword is selected, to display a list of actions corresponding to the keyword; and
an action selection module configured to, when an action is selected from the list of actions, perform processing related to the action.

2. The information processor of claim 1, further comprising:
a text type analysis module configured to identify address information in the text information; and
a secondary data acquisition module configured to acquire data from a storage indicated by the address information when the address information in the text information comprises positional information on a network,
wherein the text type analysis module is further configured to analyze the data acquired by the secondary data acquisition module and to extract a word or a word group as a keyword contained in the text information.

3. The information processor of claim 1, further comprising:
a text type analysis module configured to identify address information in the text information; and
a secondary data acquisition module configured to acquire data from a storage indicated by the address information when the address information in the text information comprises positional information of the storage in the information processor, wherein
the text type analysis module is further configured to analyze the data acquired by the secondary data acquisition module and to extract a word or a word group as a keyword contained in the text information.

4. An information processor comprising:
a text selection module configured to receive an input comprising a portion of text being displayed and to store text information contained in the portion in a storage area;
a text analysis module configured to acquire the text information stored in the storage area, to analyze the text information, and to extract a word or a word group as a keyword contained in the text information;
a keyword display module configured to display a list of keywords extracted by the text analysis module and, when a keyword is selected, to display a list of actions corresponding to the keyword; and
an action selection module configured to, when an action is selected from the list of actions, perform processing related to the action.

5. The information processor of claim 4, further comprising:
a text type analysis module configured to identify address information in the text information; and
a secondary data acquisition module configured to acquire data from a storage indicated by the address information when the address information in the text information comprises positional information on a network,
wherein the text type analysis module is further configured to analyze the data acquired by the secondary data acquisition module and to extract a word or a word group as a keyword contained in the text information.

6. The information processor of claim 4, further comprising:
a text type analysis module configured to identify address information in the text information; and
a secondary data acquisition module configured to acquire data from a storage indicated by the address information when the address information in the text information comprises positional information of the storage in the information processor,
wherein the text type analysis module is further configured to analyze the data acquired by the secondary data acquisition module and to extract a word or a word group as a keyword contained in the text information.

7. The information processor of claim 4, wherein the text selection module comprises an application program different from the text analysis module, the keyword display module, and the action selection module.

8. A computer program product embodied on a non-transitory computer-readable storage medium and comprising code that, when executed, causes a computer to:
receive an input of a portion of text being displayed by a text selection module;
analyze text information contained in the portion;
extract a word or a word group as a keyword contained in the text information by a text analysis module;
display a list of the keywords extracted by the text analysis module and, when a keyword is selected, display a list of actions corresponding to the keyword by a keyword display module; and
perform, when an action is selected from the list of actions, processing related to the action by an action selection module.

9. A computer program product embodied on a non-transitory computer-readable storage medium and comprising code that, when executed, causes a computer to:
receive an input of a portion of text being displayed and store text information contained in the portion in a storage area by a text selection module;
acquire the text information stored in the storage area, analyze the text information, and extract a word or a word group as a keyword contained in the text information by a text analysis module;
display a list of keywords extracted by the text analysis module and, when a keyword is selected, display a list of actions corresponding to the keyword by a keyword display module; and
perform, when an action is selected from the list of actions, processing related to the action by an action selection module.
